(19) United States
(12) Patent Application Publication
(10) Pub. No.: US 2025/0156699 A1
(43) Pub. Date: May 15, 2025

(54) PERFORMING POOLING OPERATIONS

(71) Applicant: Cypress Semiconductor Corporation, San Jose, CA (US)

(72) Inventors: Vijay Deep BHATT, Munich (DE); Ashutosh PANDEY, Irvine, CA (US)

(73) Assignee: Cypress Semiconductor Corporation, San Jose, CA (US)

(21) Appl. No.: 18/932,176

(22) Filed: Oct. 30, 2024

Related U.S. Application Data
(60) Provisional application No. 63/599,241, filed on Nov. 15, 2023.

(51) Int. Cl. G06N 3/063; G06N 3/08

(52) U.S. Cl. CPC G06N 3/063; G06N 3/08

(57) ABSTRACT

A coprocessor of a processing device used to perform pooling operations. The disclosed coprocessor, among other things, receives an activation tensor of a neural network model. The coprocessor applies a pooling window to the activation tensor. The coprocessor reads, from a memory device, a plurality of memory locations. For each memory location, the coprocessor stores a value from a respective memory location associated with a channel of the activation tensor to a corresponding buffer of a set of buffers. Responsive to determining a number of values in each buffer of the set of buffers matches a number of values within the pooling window applied to the activation tensor performing, for each buffer using its values, a pooling operation.

### CROSS REFERENCE TO RELATED APPLICATIONS

This Application claims the benefit of U.S. Provisional Application No. 63/599,241 filed Nov. 15, 2023, the contents of which are hereby incorporated by reference in their entirety.

### TECHNICAL FIELD

Aspects and implementations of the present disclosure relate to performing pooling operations.

### BACKGROUND

Deep Neural Networks (DNNs) are advanced machine learning models consisting of multiple layers of interconnected nodes that process and transform data, enabling the learning of complex patterns. DNNs are characterized by their depth, allowing them to model intricate relationships in data making them highly effective for tasks such as image recognition, natural language processing, and speech recognition. Thus, DNNs have been used in many AI applications, significantly advancing fields like computer vision and natural language understanding.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example computer system, in accordance with implementations of the present disclosure.

FIG. 2 is an exemplary illustration of an activation tensor of a neural network, in accordance with implementations of the present disclosure.

FIG. 3 is an exemplary illustration of the storage of the activation tensor of FIG. 2, in accordance with implementations of the present disclosure.

FIG. 4 is an exemplary illustration a pooling operations on the activation tensor of FIG. 2, in accordance with implementations of the present disclosure.

FIG. 5 depicts a flow diagram of performing the pooling operation on a coprocessor, in accordance with implementations of the present disclosure.

FIG. 6 is a block diagram illustrating an exemplary computer system, in accordance with implementations of the present disclosure.

### DETAILED DESCRIPTION

Aspects of the present disclosure relate to performing pooling operations. Deep Neural Networks (DNNs), as previously noted, are advanced machine learning models consisting of multiple interconnected layers. As data flows through these layers, computationally intensive operations are performed, with significant time spent on matrix-by-vector multiplications due to fetching the matrix/vector data and performing sum-of-product (SoP) operations. Many coprocessor, such as neural network hardware accelerators, focus primarily on optimizing the SoP operations in convolutional layers. However, pooling layers, which are used to downsize the DNNs, are often not optimized. Current implementations of pooling layers are either implemented outside a processing element, resulting in a performance bottleneck for the hardware architecture running the DNN, or inside every processing element (PE) in spatial architectures, leading to area overhead for each PE. Both approaches increase data movement within the hardware system, consequently raising power consumption.

Aspects and embodiments of the present disclosure address these and other limitations of the existing technology by implementing pooling operations of the pooling layer within the coprocessor. More specifically, in response to a request for pooling operations, the hardware coprocessor retrieves data from memory for each region of an activation tensor stored in channel-last format. The activation tensor is a multi-dimensional array that represents the output of a neural network layer, encompassing multiple channels, after applying an activation function to the layer's input. For each retrieved data for a respective region, the hardware coprocessor extracts, from a respective data, an activation value for each channel of the multiple channels of the activation tensor and populates a corresponding buffer. Each channel corresponds to a buffer of a plurality of buffers.

The coprocessor monitors each buffer. Responsive to each buffer containing all activation values for performing a pooling operation on the associated channel at a region of the associated channel identical to the current region, performs, using the activations values of a corresponding buffer, a pooling operation for the buffer. In other words, the coprocessor performs multiple pooling operations, in parallel, for each channels according to the current region. In some embodiments, the output of the multiple pooling operations may be combined and stored in memory overwriting previously stored data.

Aspects of the present disclosure overcome these deficiencies and others by performing multiple pooling operations in parallel on a coprocessor thereby improving efficiency and performance of the pooling layer of a neural network.

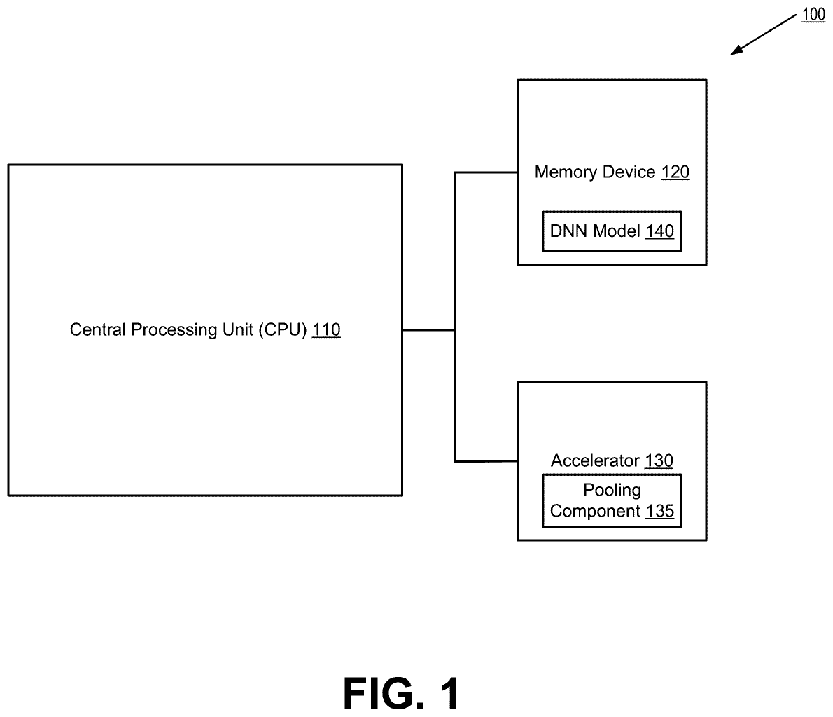

FIG. 1 illustrates a simplified diagram of a computing system 100. The computing system 100 may be a server, a workstation, a personal computer (PC), a mobile phone, a personal digital assistant (PDA), or any other suitable computing device. The computing system 100 includes a central processing unit (CPU) 110, one or more memory devices 120, and an coprocessor 130.

The CPU 110 includes various components capable of executing instructions that encode arithmetic, logical, or I/O operations. The CPU 110 may be a single-core or multi-core processor that can simultaneously execute multiple instructions. The CPU 110 can be implemented as a single integrated circuit, two or more integrated circuits, or as a component of a multi-chip module. In neural network processing, the CPU 110 orchestrates operations, managing overall control, data preparation, and task coordination.

The memory devices 120 include volatile and non-volatile memory, such as RAM, ROM, EEPROM, or any other devices capable of storing data. The memory devices 120 store neural network model parameters, large datasets, and intermediate results during processing.

The coprocessor 130 is a specialized hardware component designed to efficiently perform neural network computations. The coprocessor 130 may be implemented as a graphics processing unit (GPU), a field-programmable gate array (FPGA), or an Application-Specific Integrated Circuit (ASIC) such as a Tensor Processing Unit (TPU) or Neural Processing Unit (NPU).

In response to a user command or a pre-programmed instruction set, the CPU 110 initiates the execution of a neural network model, such as a Deep Neural Network (DNN) model 140. The CPU 110 reads the DNN model 140 from non-volatile storage within the memory devices 120 and loads the DNN model 140 into system memory (typically RAM) for faster access during operation. Depending on system capabilities and model size, the entire DNN model 140 might be loaded at once or in parts as needed. The DNN model 140 typically includes an input layer, one or more convolutional layers, activation layers, pooling layers, fully connected (dense) layers, and an output layer.

Once the DNN model 140 is loaded, the CPU 110 directs the input layer of the DNN model 140 to receive input data (e.g., image pixels) from the memory devices 120. Upon reaching a convolutional layer, the CPU 110 instructs the coprocessor 130 to begin processing. The coprocessor 130 retrieves the necessary input data and filter weights from the memory devices 120 and applies them to generate channels. Each convolutional filter scans the input data and performs element-wise multiplication with local patches, highlighting specific patterns or features.

After the coprocessor 130 completes the convolutional layer processing, the CPU 110 resumes coordination. The CPU 110 executes an activation function (e.g., Rectified Linear Unit or ReLU), applying the activation function element-wise to the output from the coprocessor 130. The activation function introduces non-linearity to the network. The CPU 110 then directs the resulting activation tensor to be stored in the memory devices 120 for subsequent use.

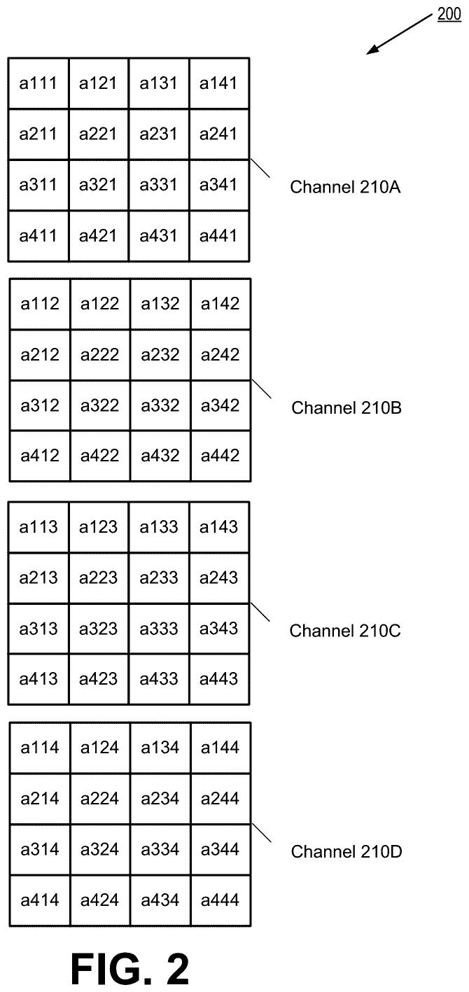

With quick reference to FIG. 2, the activation tensor (e.g., activation tensor 200) is a 3D structure where the depth dimension represents multiple channels (e.g., channels 210A, 210B, 210C, and 210D). Each channel has a 2D structure with height and width dimensions. Each entry in a channel (e.g., a111-a441 of channel 210A) corresponds to the transformed value of the original channel's pixel after applying the activation function. Since the activation tensor 200 includes 4 channels and each channel has a 4×4 grid the, activation tensor 200 is 4×4×4. The structure of activation tensor 200 allows the DNN model 140 to capture different types of features at various spatial locations within the input data.

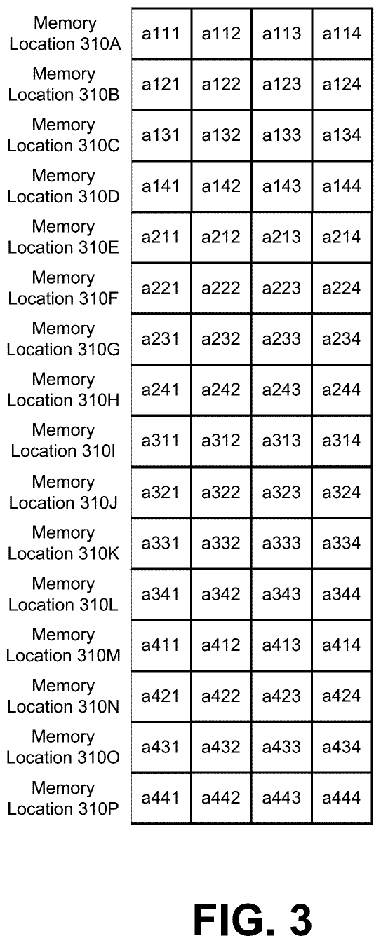

Continuing with FIG. 1, the activation tensor (e.g., activation tensor 200 of FIG. 2) is stored in memory using a channel-last format, also known as NHWC (Number of Samples (or Batch), Height, Width, Channels). The channel-last format arranges the channel (e.g., channel) dimension last in the memory layout, which is often preferred for efficiency on certain hardware architectures, particularly for convolutional operations. With quick reference to FIG. 3, the activation tensor is stored in contiguous memory using the channel-last format. The contiguous memory (e.g., memory locations 310A-n) is organized into predefined memory location sizes, each storing a predefined amount of data (e.g., 4 bytes or 32 bits). Each entry of the activation tensor is represented by a predefined number of bits (e.g., 8 bits). The number of spatial locations covered by each memory location depends on how many tensor entries fit within a single memory location (e.g., the memory location size/predefined number of bits). Accordingly, memory location 310A stores values of entry a111, al12, a113, a114, representing values from all channels for a single spatial location of the activation tensor. Subsequent memory locations continue the pattern, each storing values for all channels for the next spatial location of the activation tensor (e.g., memory location 310B stores values of entry a121, a122, a123, a124).

Continuing with FIG. 1, after the activation function is applied, the CPU 110 consults the network architecture of the DNN model 140 and identifies that a pooling layer is next. The CPU 110 then instructs the coprocessor 130, via a command, to initiate pooling operations. The coprocessor 130 activates the pooling component 135 in response. The pooling component 135 is responsible for reducing the spatial dimensions of the channels, decreasing computational load and extracting dominant features.

The pooling component 135 performs pooling operations, such as max pooling or average pooling on the data of the activation tensor. The pooling component 135, using a pooling window with a predefined size and predefined stride, determines the spatial extent of the input area (of the activation tensor) used for each successive performance of a pooling operation (i.e., pooling operation for a region within the activation tensor). The pooling component 135 sequentially accesses and retrieves (e.g., reads) data from each memory location of multiple memory locations corresponding to a current region. The current region refers to a current position of the region within the activation tensor for processing. As the pooling operation progresses, the pooling window moves across the activation tensor defining new regions for processing. As previously noted, each memory location stores values of all channels for a single spatial position. Thus, for each data retrieved from a memory location of the multiple memory locations, the pooling component 135 extracts a portion of the data (e.g., a value) associated with each channel and populates a corresponding buffer of a plurality of buffers. The plurality of buffers is organized in a sequence that mirrors the channel-last format used within each memory word (e.g., channel 1, then channel 2, and so on).

As each buffer of the plurality of buffers is being populated, the pooling component 135 continuously evaluates each buffer of the plurality of buffers to determine whether the buffer contains all values necessary for performing a pooling operation for the channel of the buffer at the current region. When the buffer contains all values necessary for performing the pooling operation for the channel of the buffer at the current region, the pooling component 135 selects the values to be used in a pooling operation at the current region from the buffer and performs the pooling operation on the selected values. Accordingly, the data obtained from each memory location of the multiple memory locations to perform a pooling operation for a specific channel at the current region can be used to perform multiple pooling operations, in parallel, for all channels at a region similar to the current region of the specific channel. For max pooling, the output of the pooling operation is the maximum value found within the input region. For average pooling, the output of the pooling operation is the average of all values in that region. The output of the multiple pooling operations can be combined (organized in a sequence that mirrors the channel-last format used within each memory word) and the combined output is stored in a memory location of the multiple memory locations. As a result, each memory location of the multiple memory locations is overwritten with the output of the multiple pooling operations corresponding a region across all channels.

After the pooling component 135 completes its operations, the output of the multiple pooling operations for each region across all channels form a down-sampled channel which is stored across one or more memory locations in the memory device(s) 120 previously used to store the activation tensor. Accordingly, after the pooling component 135 completes its operations and the CPU 110 transitions to one or more fully connected (dense) layers. The CPU 110 instructs the retrieval of the down-sampled channels from the memory device(s) 120 (e.g., the one or more memory locations overwritten with the output of the multiple pooling operations for each region across all channels). In a fully connected layer, each neuron is connected to every element of the down-sampled channels from the previous layer, allowing the network to combine features from all spatial locations. Depending on the embodiment, the CPU 110 and/or the coprocessor 130 retrieves the down-sampled channels, performs matrix multiplications using these maps as input, and applies activation functions for these dense layers. This process enables the network to create higher-level abstractions by combining the spatial features extracted and summarized by the preceding convolutional and pooling layers.

The final layer of the DNN model 140 is the output layer. This layer produces the network's final prediction or classification. The structure and activation function of the output layer depend on the specific task the DNN is designed to perform. For classification tasks, a softmax activation function is often used to produce probability distributions across possible classes. For regression tasks, a linear activation might be used instead.

Once the output layer produces its result, the CPU 110 may perform post-processing operations, such as interpreting the output, applying decision thresholds, or formatting the results for user presentation or further computational use. The entire process, from input to output, may be repeated for each new input to the DNN model 140, allowing for continuous processing of data through the neural network.

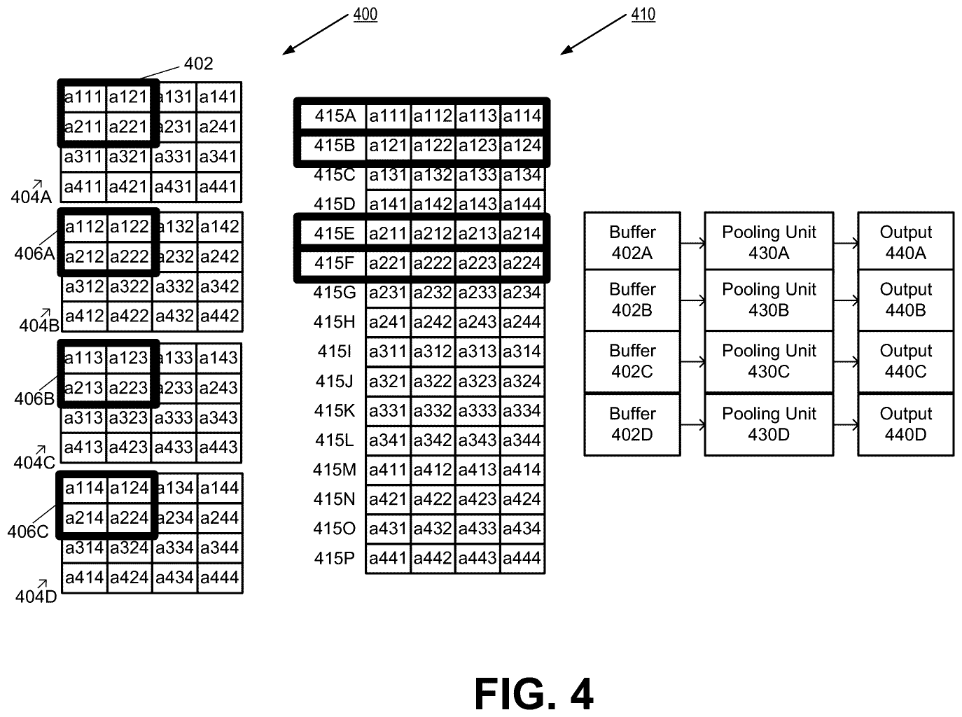

FIG. 4 illustrates the operations of the pooling component (e.g., pooling component 135 of FIG. 1, in accordance with the present disclosure. In response to receiving instructions from the CPU (e.g., CPU 110 of FIG. 1), the pooling component using a pooling window determines a current region 402 within an activation tensor 400 to be processed. The pooling component accesses and retrieves data from each memory location of multiple memory locations (e.g., memory locations 415A, 415B, 415E, and 415F) of a memory device 410 (e.g., memory device(s) 120 of FIG. 1) corresponding to the current region 402 being processed. For example, the data from memory location 415A includes values of entry a111, a112, a113, and a114, the data from memory location 415B includes values of entry a121, a122, a123, and a124, the data from memory location 415E includes values of entry a211, a212, a213, and a214, and the data from memory location 415F includes values of entry a221, a222, a223, a224.

For each data (retrieved from a memory location of the multiple memory locations), the pooling component extracts values for each channel of the activation tensor 400 (e.g., channel 404A-D) and populates a corresponding buffer of a plurality of buffers (e.g., buffers 420A-D). Specifically, buffer 420A corresponds to channel 404A, buffer 420B corresponds to channel 404B, buffer 420C corresponds to channel 404C, and buffer 420D corresponds to channel 404D.

For example, for data from memory location 415A, the pooling component extracts a value of entry a111 from the data and populates it into buffer 420A, extracts a value of entry a112 from the data and populates it into buffer 420B, extracts a value of entry a113 from the data and populates it into buffer 420C, and extracts a value of entry a114 from the data and populates it into buffer 420D. This is repeated for the data from the remaining memory locations of the multiple memory locations (e.g., memory location 415B-D).

The pooling component determines that each of the plurality of buffers (e.g., buffers 420A-D) includes values for the current region 402 across all channels (i.e., the current region 402 and pseudo regions 406A-C). The pooling component provides, from the plurality of buffers, the values for the current region 402 across all channels into corresponding pooling units (e.g., pooling units 430A-D). Specifically, pooling unit 430A corresponds to buffer 420A, pooling unit 430B corresponds to buffer 420B, pooling unit 430C corresponds to buffer 420C, and pooling unit 430D corresponds to buffer 420D. The output of each of the pooling units (e.g., output 440A-D) can be combined and stored, sequentially, in a memory location of the memory device (e.g., memory location 415A) overwriting the previously stored data.

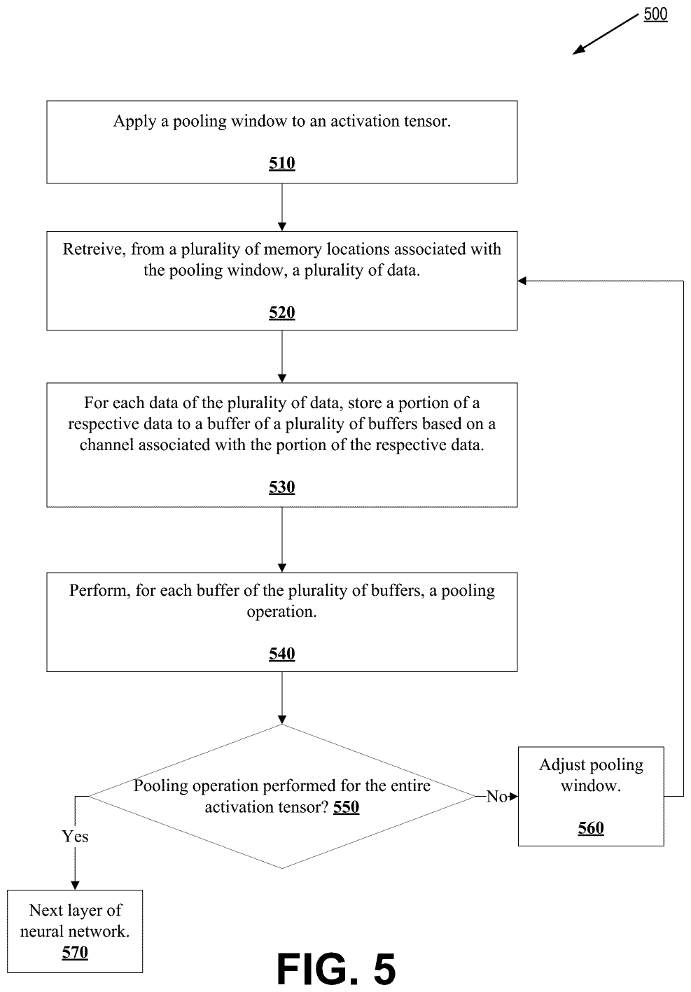

FIG. 5 is a flow diagram of a method 500 for performing the pooling operation on a coprocessor, in accordance with implementations of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the coprocessor 130 and/or the pooling component 135.

At operation 510, the processing logic applies a pooling window to an activation tensor. As previously noted, the pooling window may be a predefined size and predefined stride which determines the spatial extent of the input area (e.g., region) of the activation tensor used for each successive performance of a pooling operation. The pooling window moves across the activation tensor a predefined stride defining regions for processing.

At operation 520, the processing logic retrieves, from a plurality of memory locations associated with the pooling window, a plurality of data. As previously noted, based on the position of the pooling window (e.g., a current region), the processing logic accesses and retrieves data from each memory location of multiple memory locations corresponding to the current region (e.g., a plurality of data).

At operation 530, for each data of the plurality of data, the processing logic stores a portion of a respective data (e.g., a value) to a buffer of a plurality of buffers based on a channel associated with the portion of the respective data.

At operation 540, the processing logic performs, for each buffer of the plurality of buffers, a pooling operation. As previously noted, the processing logic determines whether each of the plurality of buffers includes values for the current region across all channels. Responsive to determining that each of the plurality of buffers does include values for the current region across all channels, the processing logic performs, for each channel, pooling operations using values stored in a buffer of the plurality of buffers associate with a respective channel. The pooling operation may be max pooling or average pooling.

At operation 550, the processing logic determines whether a pooling operation has been performed for the entire activation tensor. If no, the processing logic proceeds to operation 560 and adjusts the pooling window (i.e., moves the pooling window across the activation tensor, a predefined stride, defining regions for processing). After operation 560, the processing logic proceeds to operation 520. If yes, the processing logic proceeds to next layer (e.g., operation 570).

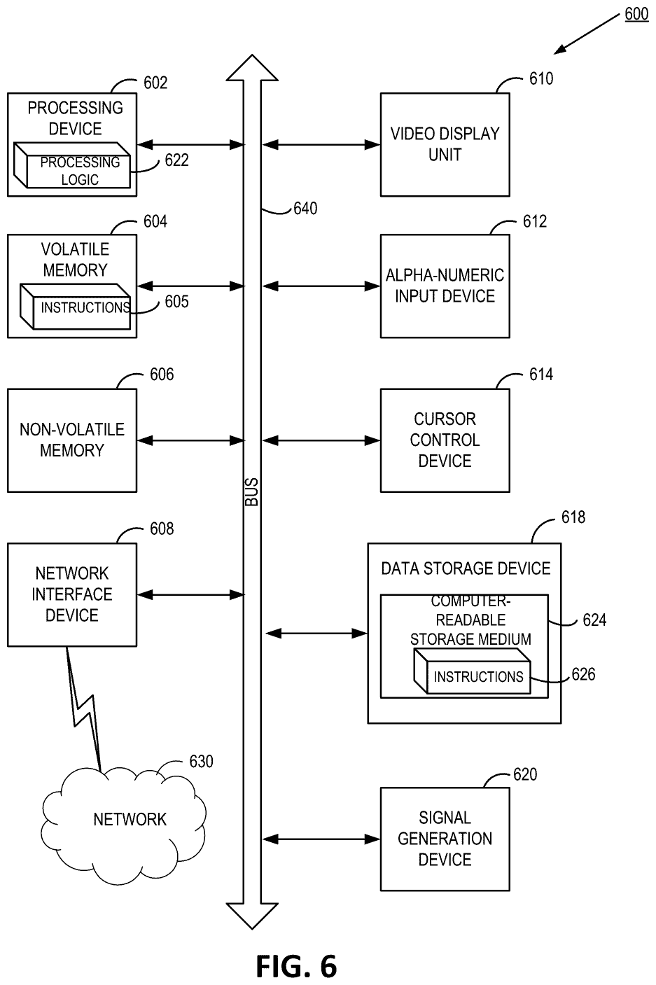

FIG. 6 is a block diagram illustrating an exemplary computer system 600, in accordance with implementations of the present disclosure. Computer system 600 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 618, which communicate with each other via a bus 640.

Processor (processing device) 602 represents one or more general-purpose processing devices such as a microprocessor, central processing unit, or the like. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 can include processing logic 622 used to perform the operations discussed herein. The processor 602 is configured to execute instructions 605 for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 620 (e.g., a speaker).

The data storage device 618 can include a non-transitory machine-readable storage medium 624 (also computer-readable storage medium) on which is stored one or more sets of instructions 626 embodying any one or more of the methodologies or functions described herein. The instructions can also reside, completely or at least partially, within the main memory 604 and/or within the processor 602 during execution thereof by the computer system 600, the main memory 604 and the processor 602 also constituting machine-readable storage media. The instructions can further be transmitted or received over a network 630 via the network interface device 608.

While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “comprises,” “comprising,” “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “block,” “layer,” “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution, and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, by a coprocessor of a processing device, a command to performing pooling operations on an activation tensor of a neural network model, wherein the activation tensor includes a set of channels;
applying a pooling window to the activation tensor;
obtaining, from a plurality of memory locations of a memory device, one or more values present in the pooling window applied to the activation tensor;
for each memory location of the plurality of memory locations, storing a value associated with a channel of set of channels into a corresponding buffer of a set of buffers, wherein each buffer is associated with a channel of the activation tensor;
responsive to determining that each buffer of the set of buffers contains the values within the pooling window when applied to a corresponding channel of the activation tensor, performing, for each buffer, a pooling operation using the values of a respective buffer.

2. The method of claim 1, further comprising:
combining an output of each pooling operation; and
storing the combined output in a memory location of the plurality of memory locations.

3. The method of claim 1, wherein applying the pooling window to the activation tensor comprises:
moving the pooling window having a predefined size across the activation tensor by a predefined stride in at least one dimension of the activation tensor between successive performance of the pooling operation for the set of buffers.

4. The method of claim 1, wherein the activation tensor is stored in the plurality of memory locations using a channel-last format.

5. The method of claim 1, wherein an output of the pooling operations a maximum value from the values of the respective buffer.

6. The method of claim 1, wherein an output of the pooling operations an average of the values of the respective buffer.

7. The method of claim 1, wherein the neural network model is a deep neural network.

8. A coprocessor coupled to a processing device and a memory device, wherein the coprocessor is to perform operations comprising:
receiving, from the processing device, a command to performing pooling operations on an activation tensor of a neural network model, wherein the activation tensor includes a set of channels;
applying a pooling window to the activation tensor;
obtaining, from a plurality of memory locations of a memory device, one or more values present in the pooling window applied to the activation tensor;
for each memory location of the plurality of memory locations, storing a value associated with a channel of set of channels into a corresponding buffer of a set of buffers, wherein each buffer is associated with a channel of the activation tensor;
responsive to determining that each buffer of the set of buffers contains the values within the pooling window when applied to a corresponding channel of the activation tensor, performing, for each buffer, a pooling operation using the values of a respective buffer.

9. The coprocessor of claim 8, wherein the coprocessor is to perform operations further comprising:
combining an output of each pooling operation; and
storing the combined output in a memory location of the plurality of memory locations.

10. The coprocessor of claim 8, wherein applying the pooling window to the activation tensor comprises:
moving the pooling window having a predefined size across the activation tensor by a predefined stride in at least one dimension of the activation tensor between successive performance of the pooling operation for the set of buffers.

11. The coprocessor of claim 8, wherein the activation tensor is stored in the plurality of memory locations using a channel-last format.

12. The coprocessor of claim 8, wherein an output of the pooling operations a maximum value from the values of the respective buffer.

13. The coprocessor rof claim 8, wherein an output of the pooling operations an average of the values of the respective buffer.

14. The coprocessor of claim 8, wherein the neural network model is a deep neural network.

15. A system comprising:
a memory device;
a processing device; and
a coprocessor, wherein the coprocessor and the processing device is coupled to the memory device, and wherein the coprocessor is to perform operations comprising:
receiving, from a processing device coupled to the coprocessor, a command to performing pooling operations on an activation tensor of a neural network model, wherein the activation tensor includes a set of channels;
applying a pooling window to the activation tensor;
obtaining, from a plurality of memory locations of a memory device, one or more values present in the pooling window applied to the activation tensor;
for each memory location of the plurality of memory locations, storing a value associated with a channel of set of channels into a corresponding buffer of a set of buffers, wherein each buffer is associated with a channel of the activation tensor;
responsive to determining that each buffer of the set of buffers contains the values within the pooling window when applied to a corresponding channel of the activation tensor, performing, for each buffer, a pooling operation using the values of a respective buffer.

16. The system of claim 15, wherein the coprocessor is to perform operations further comprising:
combining an output of each pooling operation; and
storing the combined output in a memory location of the plurality of memory locations.

17. The system of claim 15, wherein applying the pooling window to the activation tensor comprises:
moving the pooling window having a predefined size across the activation tensor by a predefined stride in at least one dimension of the activation tensor between successive performance of the pooling operation for the set of buffers.

18. The system of claim 15, wherein the activation tensor is stored in the plurality of memory locations using a channel-last format.

19. The system of claim 15, wherein an output of the pooling operation is one of: a maximum value from the values of the respective buffer or an average of the values of the respective buffer.

20. The system of claim 15, wherein the neural network model is a deep neural network.
